(19) United States
(12) Patent Application Publication
(10) Pub. No.: US 2021/0165558 A1
(43) Pub. Date: Jun. 3, 2021

(54) DISPLAY DEVICE, DISPLAY METHOD, AND DISPLAY PROGRAM

(71) Applicant: FUJIFILM Corporation, Tokyo (JP)

(72) Inventors: Kazuyuki ITAGAKI, Tokyo (JP); Takatoshi KARINO, Tokyo (JP); Makoto OZEKI, Tokyo (JP); Shinji HAYASHI, Tokyo (JP)

(73) Assignee: FUJIFILM Corporation, Tokyo (JP)

(21) Appl. No.: 17/170,102

(22) Filed: Feb. 8, 2021

Related U.S. Application Data
(63) Continuation of application No. PCT/JP2019/027466, filed on Jul. 11, 2019.

(30) Foreign Application Priority Data
Sep. 10, 2018 (JP) 2018-168944

(51) Int. Cl. G06F 3/0481; G06F 3/0484; G06T 19/00

(52) U.S. Cl. CPC G06F 3/04815; G06T 2219/2004; G06T 19/006; G06F 3/04845

(57) ABSTRACT

Even in a case where an object (OBJ2) of a movable article is placed in a virtual initial room space corresponding to an original position of the movable article in a room image, a position of a product object (IT) is not hindered. Therefore, coordinates (x2, y2, z2) corresponding to the original position of the object (OBJ2) of movable article in the room image are decided to be the placement of the object (OBJ2). On the other hand, in a case where an object (OBJ1) of a movable article is placed in a virtual initial room space corresponding to an original position of the movable article in a room image, a position of a product object (IT) is hindered (that is, the images of the objects overlap each other). Therefore, the coordinates of the object (OBJ1) of the movable article are not provided, and an elimination state is decided to be the placement of the object (OBJ1).

### CROSS-REFERENCE TO RELATED APPLICATIONS

This application is a Continuation of PCT International Application No. PCT/JP2019/027466 filed on Jul. 11, 2019, which claims priority under 35 U.S.C § 119(a) to Japanese Patent Application No. 2018-168944 filed on Sep. 10, 2018. Each of the above application(s) is hereby expressly incorporated by reference, in its entirety, into the present application.

### BACKGROUND OF THE INVENTION

### 1. Field of the Invention

The present invention relates to a display device, a display method, and a display program, in particular, relates to a display device, a display method, and a display program that present a state where an article is virtually placed in a room space to a user.

### 2. Description of the Related Art

In the related art, there is a technique of virtually placing articles such as furniture in the room space and presenting the articles to the user.

JP2015-165420A discloses that the inside of the room is three-dimensionally measured to generate a virtual space modeled three-dimensionally, and the layout simulation of placing other articles such as furniture in the virtual space may be performed.

JP2003-085356A discloses that a device absent in the home is selected as a device to be purchased, and the position of a candidate for the device to be purchased can be moved by the user with the mouse to a desired position on the virtual home screen.

JP2017-519259A discloses that furniture in the virtual room is photo-realistically described such as image capture, or is similarly described, and the description includes the active/inactive state of the device.

### SUMMARY OF THE INVENTION

In a case where the purchase of the article to be placed in the room is considered, such as furniture, home appliances, and interiors, by placing a virtual object representing the article in the virtual room space and presenting the virtual object to the user, the user can confirm the atmosphere or harmony in a case where the article is placed in the room, or the suitability of the article with respect to the size or space of the room, in advance.

However, in the related art, securing the placement space of the purchase consideration article is hindered due to the object placed in the real room, and thus the placement that maximizes the original attractiveness or value of the purchase consideration article cannot be proposed.

The present invention has been made in view of such problems, and an object thereof is to provide a display device, a display method, and a display program that can propose the attractiveness or value of a placement consideration article to a user by eliminating limitation in a virtual space of a layout of the placement consideration article due to an object actually placed in a room.

A display device according to a first aspect of the present invention comprises an image acquiring unit that acquires an image obtained by imaging an inside of a room, a measuring unit that measures space information regarding the room from the image acquired by the image acquiring unit, a placement consideration article selecting unit that allows a user to select a placement consideration article that is an article to be considered for new placement in the room, a generating unit that generates, based on the image and the space information, a virtual room space that is a space virtually representing the inside of the room, a virtual real space object virtually representing one or more articles placed in the room, and a virtual placement consideration article object virtually representing the placement consideration article selected by the user by the placement consideration article selecting unit in the virtual room space, a placing unit that decides optimum placement of the virtual placement consideration article object in the virtual room space, and decides placement of the virtual real space object in the virtual room space, and a display controller that displays the virtual room space in which the virtual real space object and the virtual placement consideration article object are placed by the placing unit on a display unit, in which in a case where optimum placement of the virtual placement consideration article object is not hindered even though the virtual real space object is placed at a virtual real space object initial position that is a position in the virtual room space corresponding to a position in the room of the one or more articles placed in the room, the placing unit places the virtual real space object at the virtual real space object initial position, and in a case where optimum placement of the virtual placement consideration article object is hindered due to placement of the virtual real space object at the virtual real space object initial position, the placing unit moves the virtual real space object from the virtual real space object initial position.

In the display device according to a second aspect of the present invention, in a case where optimum placement of the virtual placement consideration article object is hindered due to placement of the virtual real space object at the virtual real space object initial position, the placing unit may move the virtual real space object to an outside of the virtual room space.

In the display device according to a third aspect of the present invention, in a case where the virtual real space object is moved to the outside of the virtual room space, the display controller may do not display the moved virtual real space object on the display unit.

In the display device according to a fourth aspect of the present invention, in a case where optimum placement of the virtual placement consideration article object is hindered due to placement of the virtual real space object at the virtual real space object initial position, the placing unit may move the virtual real space object in the virtual room space.

In the display device according to a fifth aspect of the present invention, the display controller may display the virtual real space object in the virtual room space displayed on the display unit at a position optionally instructed by the user excluding a displayed position of the virtual placement consideration article object, and in a case where the position optionally instructed by the user is outside the virtual room space, may do not display the virtual real space object on the display unit.

The display device according to a sixth aspect of the present invention may further comprise an article database that stores information regarding one or more articles used for the placement consideration article selecting unit to allow the user to select the placement consideration article, in which the placement consideration article selecting unit allows the user to select information regarding any one or more articles from the information regarding the one or more articles stored in the article database.

In the display device according to a seventh aspect of the present invention, the information regarding the article may include information regarding an optimum layout of the article in the virtual room space, and the display controller may decide a virtual placement consideration article object initial position in the virtual room space based on the information regarding an optimum layout of the placement consideration article selected by the user, and may display the virtual placement consideration article object at the virtual placement consideration article object initial position.

In the display device according to an eighth aspect of the present invention, the article database may store a virtual placement consideration article object corresponding to one or more placement consideration articles, and the generating unit may extract a virtual placement consideration article object corresponding to the placement consideration article selected by the user from the article database to generate the virtual placement consideration article object.

In the display device according to a ninth aspect of the present invention, the generating unit may generate the virtual real space object corresponding to the one or more articles placed in the room based on a subject image of the one or more articles included in the image.

The display device according to a tenth aspect of the present invention may further comprise an object database that stores the virtual real space object corresponding to the one or more articles, in which the generating unit may extract the virtual real space object corresponding to the one or more articles placed in the room from the object database to generate the virtual real space object.

In the display device according to an eleventh aspect of the present invention, the virtual room space may include a wall, a floor, and a ceiling.

In the display device according to a twelfth aspect of the present invention, the one or more articles placed in the room may include at least one of a window, a curtain, or furniture.

In the display device according to a thirteenth aspect of the present invention, the placement consideration article may include a product that can be purchased by electronic commerce.

A display method according to a fourteenth aspect of the present invention, executed by a computer, comprises a step of acquiring an image obtained by imaging an inside of a room, a step of measuring space information regarding the room from the acquired image, a step of allowing a user to select a placement consideration article that is an article to be considered for new placement in the room, a step of generating, based on the image and the space information, a virtual room space that is a space virtually representing the inside of the room, a virtual real space object virtually representing one or more articles placed in the room, and a virtual placement consideration article object virtually representing the placement consideration article selected by the user in the virtual room space, a step of deciding optimum placement of the virtual placement consideration article object in the virtual room space, and deciding placement of the virtual real space object in the virtual room space, and a step of displaying the virtual room space in which the virtual real space object and the virtual placement consideration article object are placed, in which in a case where optimum placement of the virtual placement consideration article object is not hindered even though the virtual real space object is placed at a virtual real space object initial position that is a position in the virtual room space corresponding to a position in the room of the one or more articles placed in the room, the virtual real space object is placed at the virtual real space object initial position, and in a case where optimum placement of the virtual placement consideration article object is hindered due to placement of the virtual real space object at the virtual real space object initial position, the virtual real space object is moved from the virtual real space object initial position.

A display program according to a fifteenth aspect of the present invention allows a computer to execute the display method according to the fourteenth aspect.

According to the present invention, in a case where optimum placement of the article selected by the user is decided, the object in the real space which may hinder the placement of the article can be removed from the virtual room space. Therefore, in a case where the user considers new placement of the product to be purchased in the room, it is possible to propose the attractiveness or value of the product more than that of the article existing in the room to the user, and to reduce the loss of the sale opportunity of the product. Also, the total coordination of the room including the product to be purchased is possible, and cross-selling of the related products is possible.

### BRIEF DESCRIPTION OF THE DRAWINGS

FIG. 1 is a block configuration diagram of an image processing device 100.

FIG. 2 is a diagram showing an example of information stored in an object database.

FIG. 3 is a diagram showing an example of information stored in a product database.

FIG. 4 is a flowchart of a display method including layout presentation processing.

FIG. 5 is a diagram showing an example of real space objects OBJ1-1, OBJ1-2, and OBJ1-3 of existing articles measured from a room image.

FIG. 6 is a diagram showing an example of a width xl between right and left walls, a ceiling height yl, and a depth zl, which are dimensions of a room space S1 measured from the room image.

FIG. 7 is a diagram showing virtual real space objects OBJ2-1, OBJ2-2, and OBJ2-3 in a virtual room space S2 of the existing articles in the room space S1.

FIG. 8 is a diagram showing an example of a product selection screen for product selection based on operation of a user.

FIG. 9 is a flowchart showing processing of step S5 in detail.

FIG. 10 is a diagram showing an example of the virtual room space S2.

FIG. 11 is a diagram showing an example of optimum placement of an object IT of the selected product, which is decided by a layout deciding unit 17.

FIG. 12 is a diagram showing an example of deciding placement of the virtual real space object OBJ2-2 of a movable article.

FIG. 13 is a diagram showing an example in which a space V2 that does not hinder the position of the virtual placement consideration article object IT of product is generated.

FIG. 14 is a diagram showing an example in which the eliminated virtual real space objects OBJ2-1, and OBJ2-2 of the movable articles are placed in the space V2.

### DESCRIPTION OF THE PREFERRED EMBODIMENTS

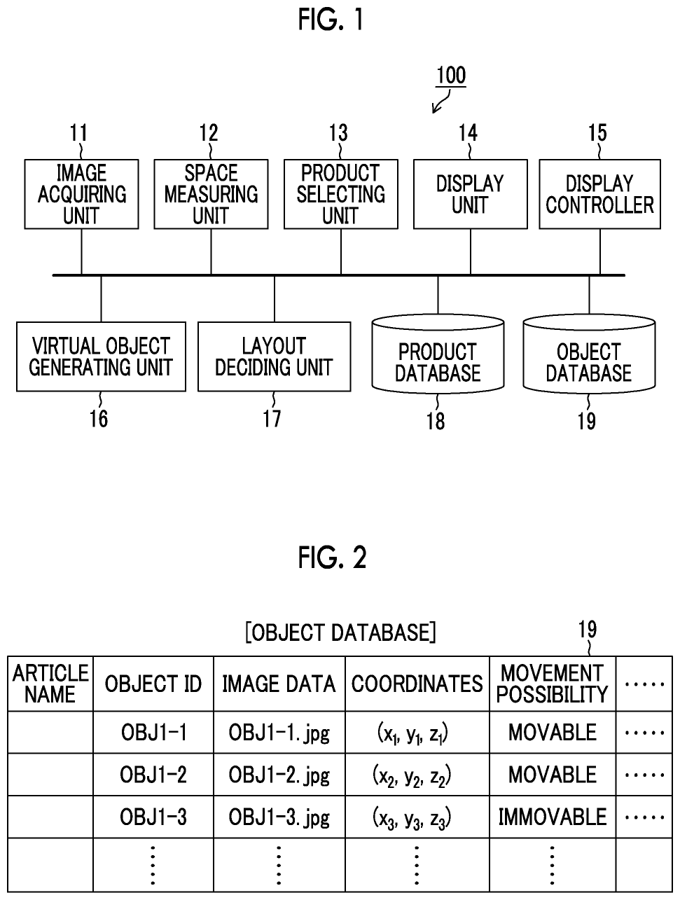

FIG. 1 is a block configuration diagram of an image processing device 100 according to a preferred embodiment of the present invention. The image processing device 100 comprises an image acquiring unit 11, a space measuring unit (measuring unit) 12, a product selecting unit (placement consideration article selecting unit) 13, a display unit 14, a display controller 15, a virtual object generating unit (generating unit) 16, a layout deciding unit (placing unit) 17, a product database (article database) 18, and an object database 19. The image acquiring unit 11, the space measuring unit 12, the product selecting unit 13, the display controller 15, the virtual object generating unit 16, and the layout deciding unit 17 may be configured by one or a plurality of processors. The processor includes a central processing unit (CPU), an application specific integrated circuit (ASIC), a graphics processing unit (GPU), and the like. The display unit 14 is configured by a display device such as a liquid crystal display. The display controller 15 is configured by a display driver integrated circuit (IC), or the like. The product database 18 and the object database 19 are configured by various storage devices such as a hard disk apparatus or a flash memory.

The image acquiring unit 11 acquires an image obtained by imaging the inside of the room by a user using a device, such as a 3D camera, that acquires space information. The 3D camera is a device in which an infrared sensor is attached to a twin-lens camera or a single-lens camera, and can measure a distance to a target object. The 3D camera includes a device that acquires the space information by combining the single-lens camera and the motion sensor, or by analyzing the information obtained by the single-lens camera.

The space measuring unit 12 measures the space information regarding the room from the image acquired by the image acquiring unit 11. For example, the space measuring unit 12 measures a width between the right and left walls, a ceiling height, and a depth which are dimensions of the room space. The space measuring unit 12 measures the shape and the position coordinate of one or a plurality of articles placed in the room space.

The product selecting unit 13 allows the user to select a placement consideration article that is an article to be considered for new placement in the room. For example, the product selecting unit 13 outputs signals for displaying a product selection screen for the user to select information regarding any one or more articles from the information regarding one or more articles stored in the product database 18 on the display unit 14 to the display controller 15.

The virtual object generating unit 16 generates the virtually represented room space and the virtually represented object based on the room image acquired by the image acquiring unit 11 and the space information measured by the space measuring unit 12. The virtual object generating unit 16 generates the virtual room space that is a space virtually representing the inside of the room based on the room image acquired by the image acquiring unit 11 and the space information measured by the space measuring unit 12. The virtual room space includes a wall, a floor, and a ceiling. The virtual object generating unit 16 generates the virtual real space object which virtually represents one or more articles actually placed in the imaged room. The virtual object generating unit 16 generates the virtual real space object corresponding to the one or more articles placed in the room based on a subject image of the one or more articles included in the room image acquired by the image acquiring unit 11. The virtual object generating unit 16 extracts the virtual real space object corresponding to the one or more articles placed in the room from the object database 19 to generate the virtual real space object. Further, the virtual object generating unit 16 generates a virtual placement consideration article object which virtually represents a placement consideration article selected by the user by the product selecting unit 13 in the virtual room space. The virtual object generating unit 16 extracts the virtual placement consideration article object corresponding to the placement consideration article selected by the user from the product database 18 to generate the virtual placement consideration article object.

The layout deciding unit 17 places the virtual real space object and the virtual placement consideration article object in the virtual room space. For example, the layout deciding unit 17 places the virtual placement consideration article object at an optimum position for the virtual placement consideration article object in the virtual room space. The layout deciding unit 17 places the virtual real space object at the position (virtual real space object initial position) in the virtual room space, which corresponds to the position in which the article is placed on the room image acquired by the image acquiring unit 11. Also, for example, the layout deciding unit 17 places the virtual placement consideration article object at the position in the virtual room space optionally instructed by the user.

The display unit 14 displays the virtual room space in which the virtual real space object and the virtual placement consideration article object are placed by the layout deciding unit 17.

The display controller 15 moves the virtual real space object and the virtual placement consideration article object in the virtual room space which are displayed by the display unit 14 from the position in which the objects are placed by the layout deciding unit 17 to the position optionally instructed by the user.

The product database 18 stores information regarding one or more articles used for the product selecting unit 13 to allow the user to select the placement consideration article. The information regarding the article includes information regarding the optimum layout of the article in the virtual room space. The product database 18 stores the virtual placement consideration article object corresponding to one or more placement consideration articles.

The object database 19 stores the virtual real space object corresponding to one or more articles.

The image processing device 100 is configured by a mobile information terminal such as a smartphone, a tablet terminal, or a digital camera, or a personal computer. The camera used by the user in a case of imaging the inside of the room, the product database 18 and the object database 19 may or may not be integrated with the image processing device 100. The product database 18 and the object database 19 are provided in another personal computer or a server, and the image processing device 100 may be accessible thereto via a network.

FIG. 2 shows an example of information stored in the object database 19. The object database 19 is a device that associates and stores an article name of the article that may be actually placed in the room space, an object identification (ID), image data of the object virtually representing the article (virtual real space object). Also, the object database 19 can associate and store the position coordinate of the article actually placed in the room space measured by the space measuring unit 12 and the movement possibility flag indicating whether the article is movable in the room.

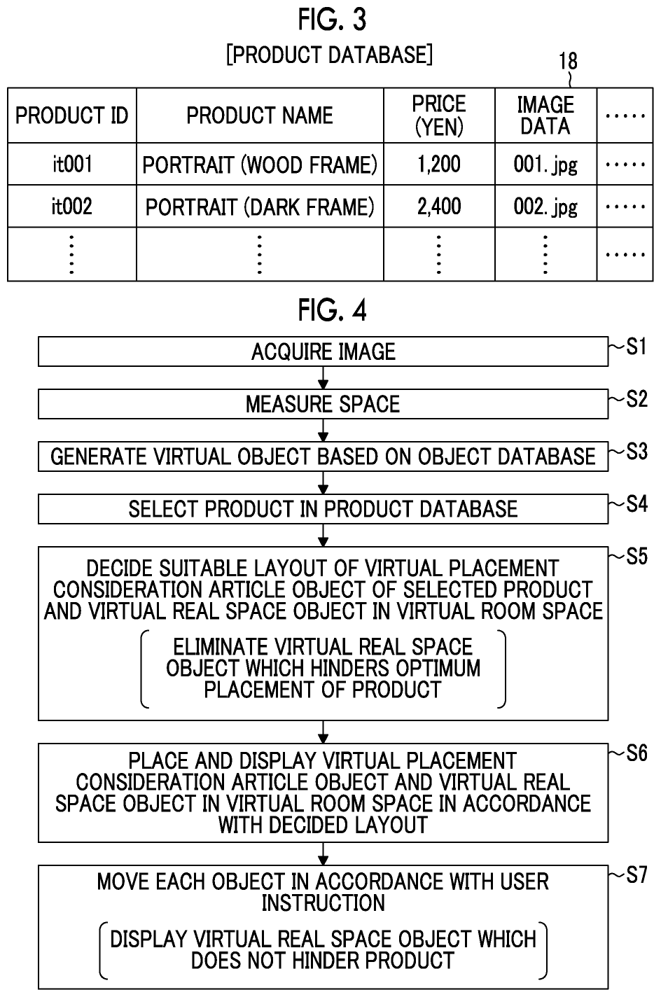

FIG. 3 shows an example of information stored in the product database 18. The product database 18 stores a product ID, a product name, a product price, and product image data which indicate the article (placement consideration article) to be considered for new placement in the room. The product database 18 is provided in a site where the product can be purchased by electronic commerce, and the image processing device 100 may be accessible thereto via a network.

FIG. 4 is a flowchart showing an embodiment of a display method including layout presentation processing executed by the image processing device 100. A display program for causing various computers (processors) to execute the processing is recorded in various computer (processor) readable recording media such as a read only memory (ROM), a CD-ROM, and a hard disk apparatus.

In the present specification, “purchase” means a paid transfer, and “product” means a paid-transferred article, but the same processing as for the product can be performed with respect to the room space in which free-transferred article is to be installed.

In step S1, the image acquiring unit 11 acquires an image (room image) in which the inside of the room is captured. The room image is, for example, a three-dimensional image captured by the 3D camera. The room space is a room space in which a product is newly purchased and installed.

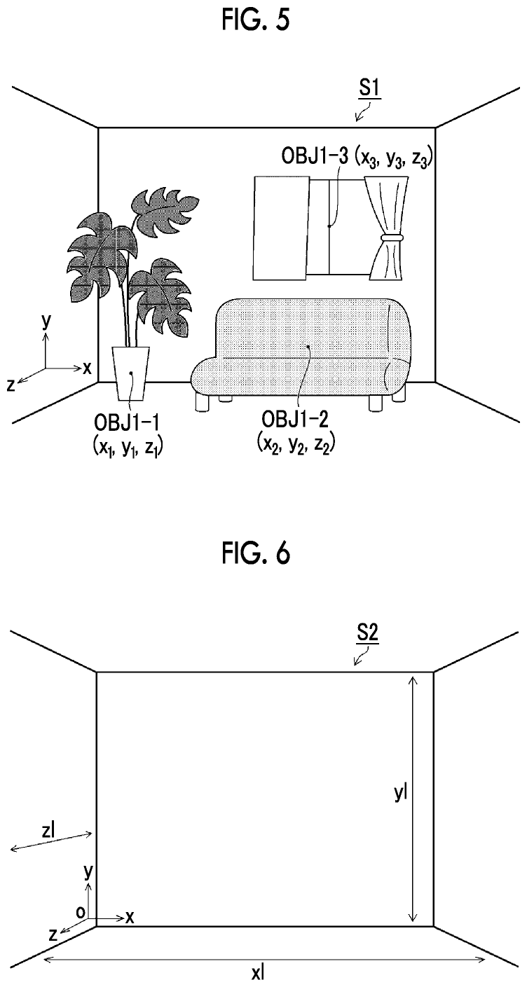

In step S2, the space measuring unit 12 measures the dimensions of the room space, and the shape and the position coordinate of the existing article which is one or a plurality of articles actually placed in the room space from the room image acquired by the image acquiring unit 11. FIG. 5 shows an example of objects (real space objects) OBJ1-1, OBJ1-2, and OBJ1-3 of the existing articles measured from a room image S. FIG. 6 shows an example of a width xl between right and left walls, a ceiling height yl, and a depth zl, which are dimensions of a room space S1 measured from the room image. The measured position coordinates of the real space objects OBJ1-1, OBJ1-2, and OBJ1-3 are respectively associated with the article name, the object ID, and the image data of the virtual real space object, and stored in the object database 19.

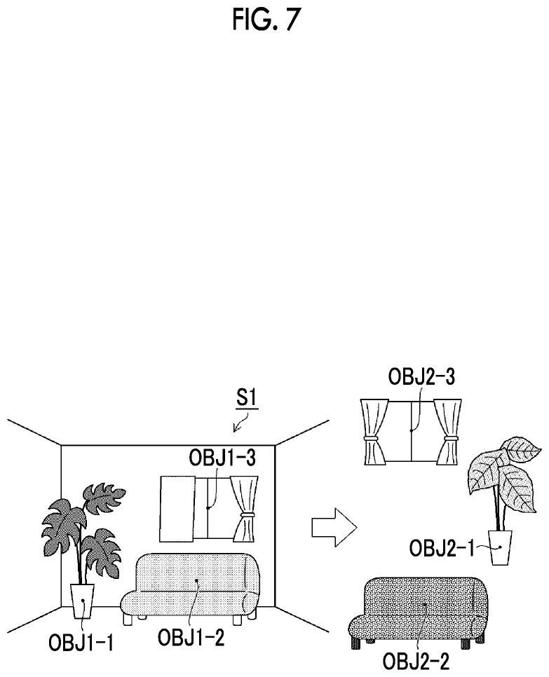

In step S3, the virtual object generating unit 16 which is a part of the generating unit generates the objects (virtual real space objects) OBJ2-1, OBJ2-2, and OBJ2-3 in the virtual room space S2, which correspond to the shapes of the real space objects OBJ1-1, OBJ1-2, and OBJ1-3 of one or a plurality of existing articles placed in the room space S1 measured by the space measuring unit 12, based on the object database 19 (see FIG. 7).

For example, the virtual object generating unit 16 estimates the article name of the article corresponding to the article (same or similar article) based on the measured shape of the existing article by machine learning or the like. The virtual object generating unit 16 specifies and extracts the object data including the image data of the article corresponding to the estimated article name from the list of the object data of the article stored in the object database 19. The extracted object data includes the virtual real space object.

Alternatively, the virtual object generating unit 16 may generate the virtual real space object of the existing article by simplifying the article portion by reducing the color of the subject image of the existing article measured from the image or approximating the shape with a polygonal shape.

FIG. 7 shows the virtual real space objects OBJ2-1, OBJ2-2, and OBJ2-3 generated corresponding to the real space objects OBJ1-1, OBJ1-2, and OBJ1-3 of the existing articles placed in the room space S1.

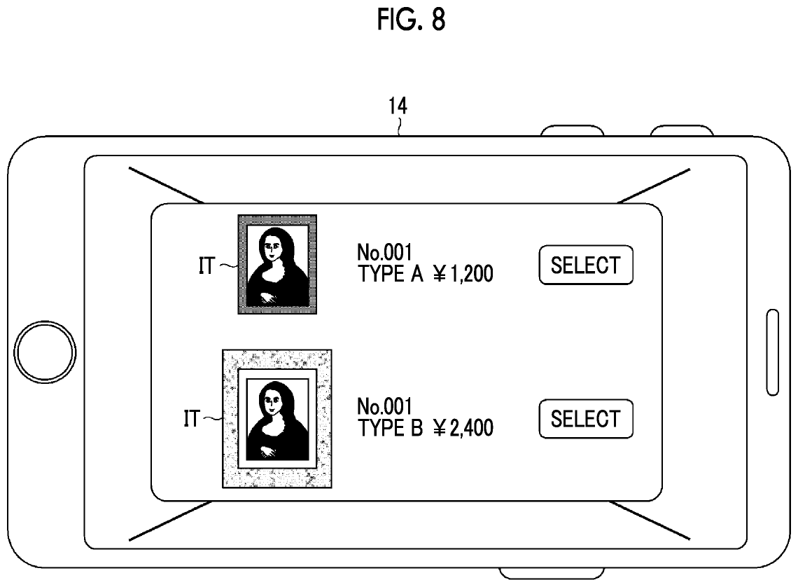

In step S4, the product selecting unit 13 selects the product name of any product (placement consideration article) from the product database 18 based on the operation by the user. FIG. 8 shows an example of a product selection screen for the user to select the product considered for purchasing.

In step S5, the layout deciding unit 17 functioning as the placing unit decides the placement of the virtual placement consideration article object corresponding to the product selected in step S4 in the virtual room space S2, and the placement of the virtual real space object corresponding to the existing article measured in the room space S1 in the virtual room space S2. The details of the processing will be described below.

In step S6, the display controller 15 displays the virtual room space S2 in which the virtual placement consideration article object corresponding to the selected product name and the virtual real space object corresponding to the existing article measured in the room space S1 are placed on the display unit 14 in accordance with the placement decided by the layout deciding unit 17.

In step S7, the display controller 15 moves the displayed position of the virtual placement consideration article object of the product corresponding to the selected product name and/or the virtual real space object corresponding to one or a plurality of existing articles to any position in the virtual room space S2 in accordance with the operation of the user.

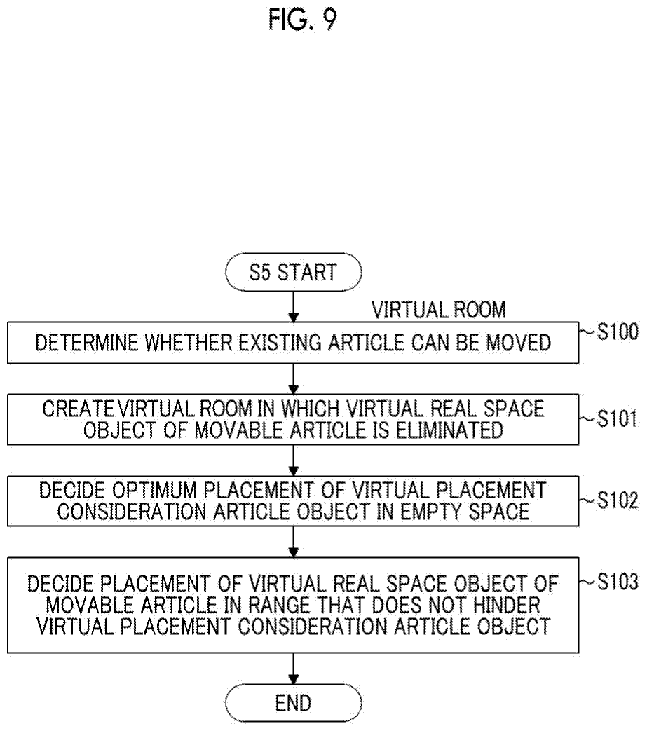

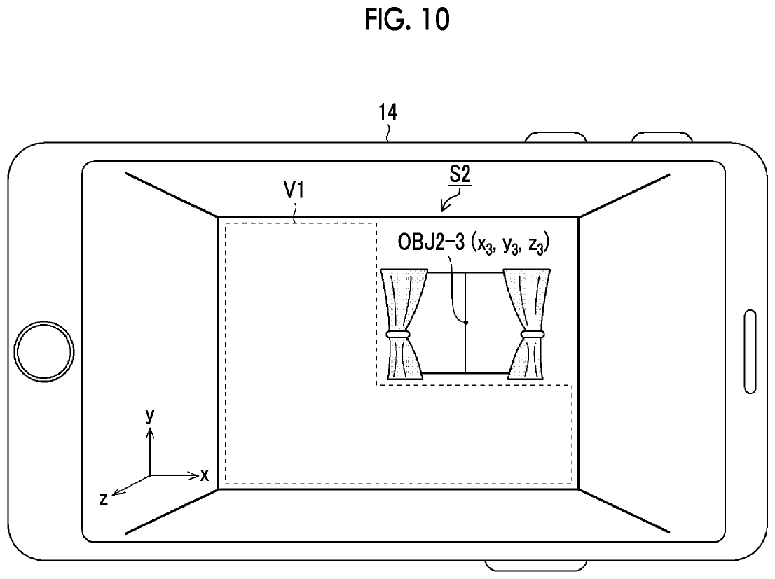

FIG. 9 is a flowchart showing processing of step S5 in detail.

In step S100, the layout deciding unit 17 determines whether each existing article can be moved. For example, as shown in FIG. 5, in a case where the real space objects OBJ1-1, OBJ1-2, and OBJ1-3 of the existing articles in the room space S1 are measured, the layout deciding unit 17 determines whether the real space objects OBJ1-1, OBJ1-2, and OBJ1-3 of the existing articles each can be physically moved. The determination may be performed by using machine learning algorithm that determines whether the existing article can be moved, or a reference table in which the movement possibility is defined for each type of article in advance.

In the room space S1 shown in FIG. 5, it is determined that the real space objects OBJ1-1 (that is, flower pot) and OBJ1-2 (that is, sofa (furniture)) of the existing articles can be moved, and the real space object OBJ1-3 (that is, a set of windows and curtains) cannot be moved. The determination result of the movement possibility of each existing article may be stored in the object database 19. Hereinafter, the existing article determined to be movable is referred to as a movable article, and the existing article determined to be immovable is referred to as an immovable article.

In step S101, the layout deciding unit 17 creates the virtual room space S2 that is a virtual room space in which the movable article is eliminated from the room image. The virtual room space S2 is a virtual space in which the measured three-dimensional real space, that is, the room space is converted into the coordinate of the room space represented by the three-dimensional computer graphics (CG).

FIG. 10 is an example of the virtual room space S2. The virtual room space S2 shown in FIG. 10 is the three-dimensional CG of the room space in which only the virtual real space object OBJ2-3 corresponding to the shape of the real space object OBJ1-3 that is the immovable article is present, and the virtual real space objects OBJ2-1 and OBJ2-2 corresponding to the shapes of the real space objects OBJ1-1 and OBJ1-2 that are the movable articles are eliminated. A portion in which the virtual real space objects OBJ2-1 and OBJ2-2 of the movable articles are eliminated is recognized by the layout deciding unit 17 as an empty space V1.

In step S102, the layout deciding unit 17 decides the optimum placement of the object (virtual placement consideration article object) IT of the product selected in step S4 in the empty space V1 of the virtual room space S2. That is, the layout deciding unit 17 decides the virtual placement consideration article object initial position that is a position in which the virtual placement consideration article object is initially displayed in the virtual room space.

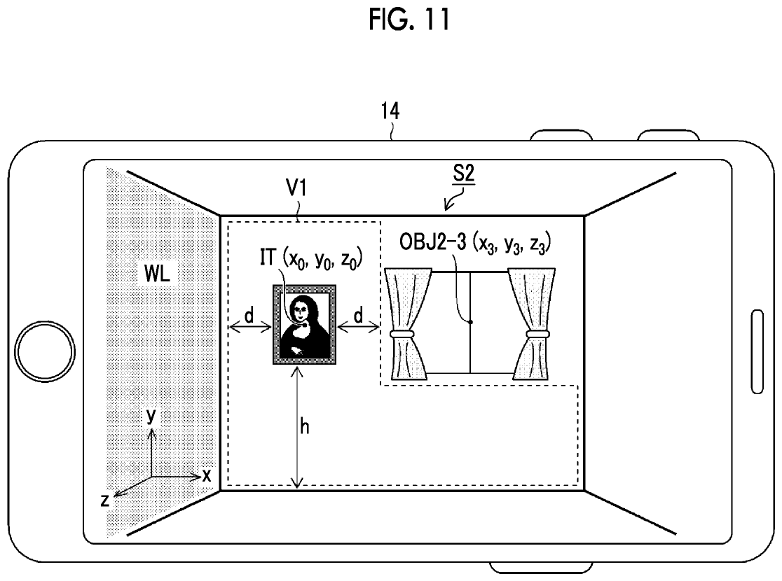

FIG. 11 shows an example of optimum placement of the virtual placement consideration article object IT of the selected product, which is decided by a layout deciding unit 17. In FIG. 11, as the optimum placement of the virtual placement consideration article object IT of the product, coordinates (x0, y0, z0) in which a height h from the floor is about the line of sight (for example, h=y0=150 cm), and a distance from the left end portion of the virtual real space object OBJ2-3 of the immovable article to the right end of the virtual placement consideration article object IT and a distance from the left wall surface WL to the left end of the virtual placement consideration article object IT are equidistant d are the center of the virtual placement consideration article object IT. The information regarding the optimum placement may be stored for each product ID as items in the product database 18.

In step S103, the layout deciding unit 17 decides the placement of the virtual real space object corresponding to the movable article in the virtual room space S2 in a range in which the optimum placement of the virtual placement consideration article object IT is not hindered.

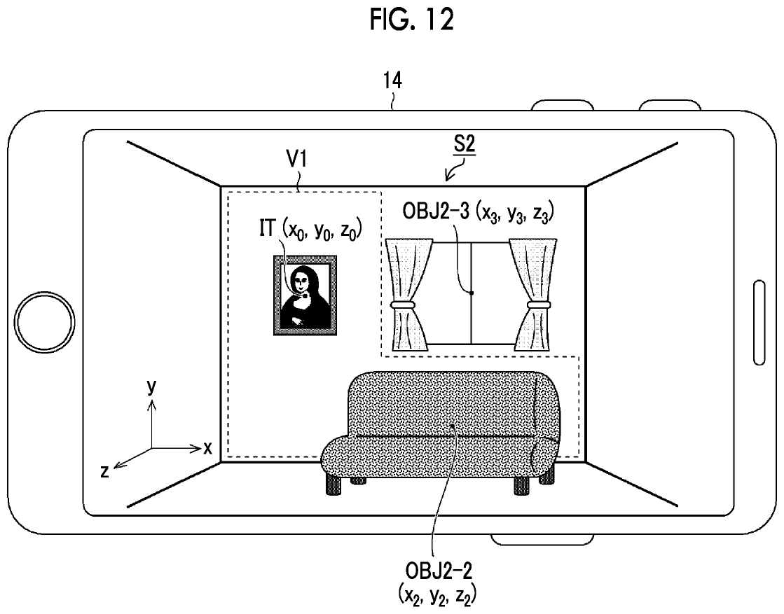

FIG. 12 shows an example of deciding placement of the virtual real space object OBJ2-2 corresponding to the movable article. In FIG. 12, even in a case where the virtual real space object OBJ2-2 corresponding to the real space object OBJ1-2 that is the movable article is placed in the virtual real space object initial position (virtual room space initial position) of the virtual room space S2 corresponding to the position of the real space object OBJ1-2 in the room image S, it does not hinder the position of the virtual placement consideration article object IT of the product. Therefore, coordinates (x2, y2, z2) corresponding to the position of the real space object OBJ1-2 of the movable article in the room image S are decided to be the placement of the virtual real space object OBJ2-2. Even in a case where both hinder each other, as long as the hindrance is eliminated by finely adjusting, by a few dots, the coordinates corresponding to the position of the real space object OBJ1-2 of the movable article, the position after fine adjustment may be decided to be the placement of the virtual real space object OBJ2-2. That is, in a case where the optimum placement of the virtual placement consideration article object IT is not hindered even though the virtual real space object OBJ2-2 is placed at the virtual real space object initial position that is a position in the virtual room space S2, which corresponds to the position in the room space S1 of one or more real space objects OBJ1-2 placed in the room space S1, the layout deciding unit 17 places the virtual real space object OBJ2-2 at the virtual real space object initial position.

On the other hand, in a case where the virtual real space object OBJ2-1 of the movable article is placed at the virtual real space object initial position corresponding to the original position of the movable article in the room image, it hinders the position of the virtual placement consideration article object IT of the product (that is, the virtual real space object OBJ2-1 and the virtual placement consideration article object IT overlap each other). Therefore, the coordinates of the virtual real space object OBJ2-1 of the movable article are not provided, and an elimination state is decided to be the placement of the virtual real space object OBJ2-1. However, even in a case where both hinder each other, as long as the hindrance is eliminated by finely adjusting the coordinates corresponding to the original position of the virtual real space object OBJ2-1, the position after fine adjustment may be decided to be the placement of the virtual real space object OBJ2-1. That is, in a case where optimum placement of the virtual placement consideration article object IT is hindered due to placement of the virtual real space object OBJ2-1 at the virtual real space object initial position, the layout deciding unit 17 moves the virtual real space object OBJ2-1 from the virtual real space object initial position. Particularly, in a case where optimum placement of the virtual placement consideration article object IT is hindered due to placement of the virtual real space object OBJ2-1 at the virtual real space object initial position, the layout deciding unit 17 moves the virtual real space object OBJ2-1 to the outside of the virtual room space S2. Alternatively, in a case where optimum placement of the virtual placement consideration article object IT is hindered due to placement of the virtual real space object OBJ2-1 at the virtual real space object initial position, the layout deciding unit 17 moves the virtual real space object OBJ2-1 in the virtual room space S2. In a case where the virtual real space object OBJ2-1 is moved to the outside of the virtual room space S2, the display controller 15 does not display the moved virtual real space object OBJ2-1 on the display unit 14.

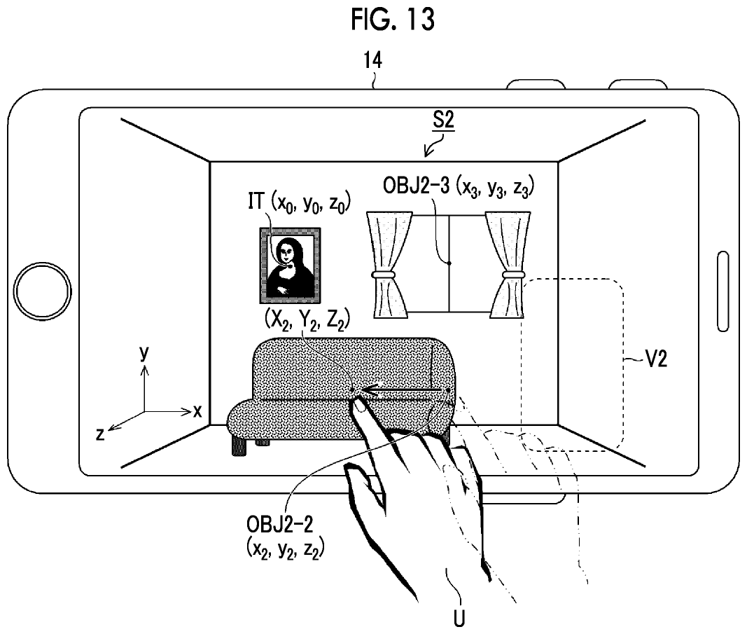

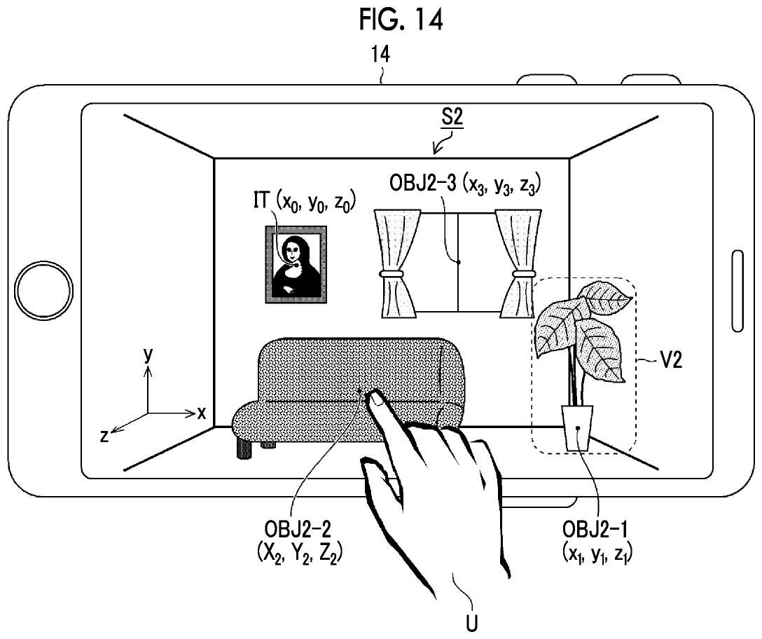

As shown in FIG. 13, in a case where the space V2 that does not hinder the position of the virtual placement consideration article object IT of the product is generated as a result that the movement source position including the virtual real space object initial position of the virtual real space object OBJ2-2 of the movable article is changed to the movement destination position by the swipe operation of the user in step S7, as shown in FIG. 14, the virtual real space object OBJ2-1 of the eliminated movable article may be placed in the space V2. From this state, the placement coordinates of the virtual placement consideration article object IT of the product and the virtual real space objects OBJ2-1 and OBJ2-2 of the movable articles may be changed in accordance with the instruction of the user. Also, the virtual real space object OBJ2-1 or OBJ2-2 may be eliminated by swiping toward the outside of the screen, and the eliminated virtual real space object OBJ2-1 or OBJ2-2 may be returned in the virtual room space S2. Also, the position of the virtual placement consideration article object IT of the product can be optionally changed by the swipe operation by the user.

As described above, in a case where the user decides the optimum placement in the room space of the product optionally selected from the product database 18, the virtual real space object OBJ2-1 corresponding to the real space object OBJ1-1 of the existing article in the room space, which hinders the optimum placement of the product can be eliminated from the virtual room space S2. Therefore, in a case where the user considers new placement of the product to be purchased in the room space S1, it is possible to propose the attractiveness or value of the product to be newly purchased to the user without the influence of the existing article (movable article) in the room space S1 and to reduce the loss of the sale opportunity of the product. Also, the total coordination of the room including the product to be purchased or existing article in the room space is possible, and cross-selling of the related products is possible.

From the above description, the display device according to the following supplementary note 1 can be grasped.

[Supplementary Note 1]

A display device comprising a processor, in which the processor acquires an image obtained by imaging an inside of a room, measures space information regarding the room from the acquired image, allows a user to select a placement consideration article that is an article to be considered for new placement in the room, generates, based on the image and the space information, a virtual room space that is a space virtually representing the inside of the room, a virtual real space object virtually representing one or more articles placed in the room, and a virtual placement consideration article object virtually representing the placement consideration article selected by the user by the placement consideration article selecting unit in the virtual room space, decides optimum placement of the virtual placement consideration article object in the virtual room space, and decides placement of the virtual real space object in the virtual room space, and displays the virtual room space in which the virtual real space object and the virtual placement consideration article object are placed, and in a case where optimum placement of the virtual placement consideration article object is not hindered even though the virtual real space object is placed at a virtual real space object initial position that is a position in the virtual room space corresponding to a position in the room of the one or more articles placed in the room, the virtual real space object is placed at the virtual real space object initial position, and in a case where optimum placement of the virtual placement consideration article object is hindered due to placement of the virtual real space object at the virtual real space object initial position, the virtual real space object is moved from the virtual real space object initial position.

### EXPLANATION OF REFERENCES

11: image acquiring unit
12: space measuring unit
13: product selecting unit
14: display unit
15: display controller
16: virtual object generating unit
17: layout deciding unit
18: product database
19: object database
100: image processing device

What is claimed is:

1. A display device comprising:
an image acquiring unit that acquires an image obtained by imaging an inside of a room;
a measuring unit that measures space information regarding the room from the image acquired by the image acquiring unit;
a placement consideration article selecting unit that allows a user to select a placement consideration article that is an article to be considered for new placement in the room;
a generating unit that generates, based on the image and the space information, a virtual room space that is a space virtually representing the inside of the room, a virtual real space object virtually representing one or more articles placed in the room, and a virtual placement consideration article object virtually representing the placement consideration article selected by the user by the placement consideration article selecting unit in the virtual room space;
a placing unit that decides optimum placement of the virtual placement consideration article object in the virtual room space, and decides placement of the virtual real space object in the virtual room space; and
a display controller that displays the virtual room space in which the virtual real space object and the virtual placement consideration article object are placed by the placing unit on a display unit,
wherein in a case where optimum placement of the virtual placement consideration article object is not hindered even though the virtual real space object is placed at a virtual real space object initial position that is a position in the virtual room space corresponding to a position in the room of the one or more articles placed in the room, the placing unit places the virtual real space object at the virtual real space object initial position, and in a case where optimum placement of the virtual placement consideration article object is hindered due to placement of the virtual real space object at the virtual real space object initial position, the placing unit moves the virtual real space object from the virtual real space object initial position.

2. The display device according to claim 1,
wherein in a case where optimum placement of the virtual placement consideration article object is hindered due to placement of the virtual real space object at the virtual real space object initial position, the placing unit moves the virtual real space object to an outside of the virtual room space.

3. The display device according to claim 2,
wherein in a case where the virtual real space object is moved to the outside of the virtual room space, the display controller does not display the moved virtual real space object on the display unit.

4. The display device according to claim 1,
wherein in a case where optimum placement of the virtual placement consideration article object is hindered due to placement of the virtual real space object at the virtual real space object initial position, the placing unit moves the virtual real space object in the virtual room space.

5. The display device according to claim 4,
wherein in a case where optimum placement of the virtual placement consideration article object is hindered due to placement of the virtual real space object at the virtual real space object initial position, the placing unit moves the virtual real space object to an outside of the virtual room space.

6. The display device according to claim 5,
wherein in a case where the virtual real space object is moved to the outside of the virtual room space, the display controller does not display the moved virtual real space object on the display unit.

7. The display device according to claim 1,
wherein the display controller displays the virtual real space object in the virtual room space displayed on the display unit at a position optionally instructed by the user excluding a displayed position of the virtual placement consideration article object, and in a case where the position optionally instructed by the user is outside the virtual room space, does not display the virtual real space object on the display unit.

8. The display device according to claim 1, further comprising an article database that stores information regarding one or more articles used for the placement consideration article selecting unit to allow the user to select the placement consideration article,
wherein the placement consideration article selecting unit allows the user to select information regarding any one or more articles from the information regarding the one or more articles stored in the article database.

9. The display device according to claim 8,
wherein in a case where optimum placement of the virtual placement consideration article object is hindered due to placement of the virtual real space object at the virtual real space object initial position, the placing unit moves the virtual real space object to an outside of the virtual room space.

10. The display device according to claim 8,
wherein the information regarding the article includes information regarding an optimum layout of the article in the virtual room space, and
the display controller decides a virtual placement consideration article object initial position in the virtual room space based on the information regarding an optimum layout of the placement consideration article selected by the user, and displays the virtual placement consideration article object at the virtual placement consideration article object initial position.

11. The display device according to claim 8,
wherein the article database stores a virtual placement consideration article object corresponding to one or more placement consideration articles, and
the generating unit extracts a virtual placement consideration article object corresponding to the placement consideration article selected by the user from the article database to generate the virtual placement consideration article object.

12. The display device according to claim 1,
wherein the generating unit generates the virtual real space object corresponding to the one or more articles placed in the room based on a subject image of the one or more articles included in the image.

13. The display device according to claim 12,
wherein in a case where optimum placement of the virtual placement consideration article object is hindered due to placement of the virtual real space object at the virtual real space object initial position, the placing unit moves the virtual real space object to an outside of the virtual room space.

14. The display device according to claim 1, further comprising an object database that stores the virtual real space object corresponding to the one or more articles,
wherein the generating unit extracts the virtual real space object corresponding to the one or more articles placed in the room from the object database to generate the virtual real space object.

15. The display device according to claim 14,
wherein in a case where optimum placement of the virtual placement consideration article object is hindered due to placement of the virtual real space object at the virtual real space object initial position, the placing unit moves the virtual real space object to an outside of the virtual room space.

16. The display device according to claim 1,
wherein the virtual room space includes a wall, a floor, and a ceiling.

17. The display device according to claim 1,
wherein the one or more articles placed in the room include at least one of a window, a curtain, or furniture.

18. The display device according to claim 1,
wherein the placement consideration article includes a product that can be purchased by electronic commerce.

19. A display method executed by a computer, the method comprising:
a step of acquiring an image obtained by imaging an inside of a room;
a step of measuring space information regarding the room from the acquired image;
a step of allowing a user to select a placement consideration article that is an article to be considered for new placement in the room;
a step of generating, based on the image and the space information, a virtual room space that is a space virtually representing the inside of the room, a virtual real space object virtually representing one or more articles placed in the room, and a virtual placement consideration article object virtually representing the placement consideration article selected by the user in the virtual room space;
a step of deciding optimum placement of the virtual placement consideration article object in the virtual room space, and deciding placement of the virtual real space object in the virtual room space; and
a step of displaying the virtual room space in which the virtual real space object and the virtual placement consideration article object are placed,
wherein in a case where optimum placement of the virtual placement consideration article object is not hindered even though the virtual real space object is placed at a virtual real space object initial position that is a position in the virtual room space corresponding to a position in the room of the one or more articles placed in the room, the virtual real space object is placed at the virtual real space object initial position, and in a case where optimum placement of the virtual placement consideration article object is hindered due to placement of the virtual real space object at the virtual real space object initial position, the virtual real space object is moved from the virtual real space object initial position.

20. A non-transitory computer readable recording medium storing a display program for causing a computer to execute the display method according to claim 19.
